(19) United States
(12) Patent Application Publication
(10) Pub. No.: US 2024/0400137 A1
(43) Pub. Date: Dec. 5, 2024

(54) FIRST JOINING MEMBER, SECOND JOINING MEMBER, AND JOINING STRUCTURE

(71) Applicants: FUTABA INDUSTRIAL CO., LTD., Okazaki-shi (JP); TOYOTA JIDOSHA KABUSHIKI KAISHA, Toyota-shi (JP)

(72) Inventors: Norito Nishizawa, Okazaki-shi (JP); Mikako Takahashi, Okazaki-shi (JP); Kota Takahashi, Okazaki-shi (JP); Masahito Yabuoshi, Chiryu-shi (JP)

(21) Appl. No.: 18/680,710

(22) Filed: May 31, 2024

(30) Foreign Application Priority Data
Jun. 2, 2023 (JP) 2023-091661

(51) Int. Cl. B62D 27/02; B62D 25/14

(52) U.S. Cl. CPC B62D 27/023; B62D 25/145

(57) ABSTRACT

A first joining member configured to be used to join an instrument panel reinforcement to a vehicle body includes upper and lower body fastening surfaces to be fastened to the vehicle body. The first joining member is configured to be able to hold the instrument panel reinforcement between the upper and lower body fastening surfaces. There is defined an imaginary line that is orthogonal to an imaginary plane connecting the upper and lower body fastening surfaces, and passes through a center axis, extending in a vehicle-width direction, of the instrument panel reinforcement held by the first joining member. A distance along the imaginary line from the center axis to the imaginary plane is equal to or shorter than a distance along the imaginary line from the center axis to an outer circumferential surface of the instrument panel reinforcement.

### CROSS-REFERENCE TO RELATED APPLICATIONS

This application claims the benefit of Japanese Patent Application No. 2023-091661 filed on Jun. 2, 2023 with the Japan Patent Office, the disclosure of which is incorporated herein by reference in its entirety.

### BACKGROUND

The present disclosure relates to a joining member used to join an instrument panel reinforcement and a body of a vehicle.

Japanese Unexamined Patent Application Publication No. 2001-010509 discloses a bracket. The bracket disclosed is a joining member used to join, to a body of a vehicle, an end of an instrument panel reinforcement that is in the form of a pipe extending in a vehicle-width direction and supports a steering. The bracket comprises an attachment surface to be attached to the body of the vehicle; and a bent surface that extends out from an edge of the attachment surface perpendicularly to the attachment surface and is formed so as to surround the attachment surface. The bent surface includes two joining parts that face each other in the vehicle-width direction and is configured to be joined to the instrument panel reinforcement.

### SUMMARY

However, since the bracket is formed so as to surround the instrument panel reinforcement with the attachment surface and the bent surface in order to obtain stiffness, there has been a problem that the weight of the bracket increases, thereby militating against light-weighting of the vehicle.

In one aspect of the present disclosure, it is desirable to provide a joining member that can both reduce weight increase and improve stiffness.

One aspect of the present disclosure provides a first joining member configured to be used to join, to a body of a vehicle (vehicle body), an instrument panel reinforcement to be mounted in the vehicle in an extending manner in a vehicle-width direction. The first joining member comprises an upper body fastening surface and a lower body fastening surface. The upper body fastening surface is configured to fasten the vehicle body thereto. The lower body fastening surface is located downwards of the upper body fastening surface, and is configured to fasten the vehicle body thereto. The first joining member is configured to be able to hold the instrument panel reinforcement between the upper body fastening surface and the lower body fastening surface. There is defined an imaginary line that is orthogonal to an imaginary plane connecting the upper body fastening surface and the lower body fastening surface, and passes through a center axis, extending in the vehicle-width direction, of the instrument panel reinforcement held by the first joining member. A distance along the imaginary line from the center axis to the imaginary plane is equal to or shorter than a distance along the imaginary line from the center axis to an outer circumferential surface of the instrument panel reinforcement.

The above configuration easily shortens a length of a part of a path (transmission path) for transmitting a force from a steering supported by the instrument panel reinforcement to the vehicle body. That is, the above configuration easily shortens lengths of respective paths coupling the instrument panel reinforcement and the upper body fastening surface, and the instrument panel reinforcement and the lower body fastening surface. Due to shortening of the part of the force transmission path, stiffness of the first joining member can be improved. As a result, the configuration of the first joining member is easily simplified and therefore, the first joining member can be inhibited from increasing in weight.

In one aspect of the present disclosure, the first joining member may be configured to cover a part of the outer circumferential surface of the instrument panel reinforcement in a circumferential direction around the outer circumferential surface. At least one of a first fastening hole provided in the upper body fastening surface or a first fastening hole provided in the lower body fastening surface may be located in the vicinity of the instrument panel reinforcement. Such a configuration allows the first joining member to hold the instrument panel reinforcement without covering the entirety of the outer circumferential surface of the instrument panel reinforcement in the circumferential direction. Therefore, as compared to a configuration of covering the entirety of the outer circumferential surface in the circumferential direction, the first joining member can be inhibited from increasing in weight. Furthermore, since the at least one first fastening hole is located in the vicinity of the instrument panel reinforcement, a length of a part of the transmission path is easily shortened. That is, a length of a path coupling the instrument panel reinforcement and at least one of the first fastening hole in the upper body fastening surface or the first fastening hole in the lower body fastening surface is easily shortened. Therefore, the stiffness of the first joining member can be improved.

In one aspect of the present disclosure, the first joining member may further comprise a coupling portion that couples the upper body fastening surface and the lower body fastening surface, and is configured to hold the outer circumferential surface of the instrument panel reinforcement. In such a configuration, the first joining member can be formed with a single component.

In one aspect of the present disclosure, the coupling portion may have a length in the vehicle-width direction longer than respective lengths of the upper body fastening surface and the lower body fastening surface in the vehicle-width direction. Furthermore, the coupling portion may include a cutout at an edge thereof in the vehicle-width direction that extends in the circumferential direction around the outer circumferential surface of the instrument panel reinforcement. Such a configuration allows the coupling portion to contact the outer circumferential surface of the instrument panel reinforcement in a fixed length along the center axis, while enabling reduction in area of the entire coupling portion due to the cutout.

One aspect of the present disclosure provides a second joining member configured to be used to join, to a body of a vehicle, an instrument panel reinforcement to be mounted in the vehicle in an extending manner in a vehicle-width direction. The second joining member comprises an instrument panel fastening surface and an extending surface. The instrument panel fastening surface is configured to fasten the instrument panel reinforcement thereto. The extending surface extends out from an edge of the instrument panel fastening surface. The instrument panel fastening surface is provided with a second fastening hole. The extending surface is provided with, at an edge thereof, a weld portion that joins the extending surface and the vehicle body. The second joining member is formed so as to be substantially flat from the weld portion in the extending surface to the second fastening hole in the instrument panel fastening surface.

The above configuration easily shortens a length of a part of the transmission path, that is a length of a path coupling the second fastening hole in the instrument panel fastening surface and the vehicle body. Due to shortening of the part of the transmission path, stiffness of the second joining member can be improved. As a result, the configuration of the second joining member is easily simplified. Therefore, when the second joining member is combined with another member configured to join the instrument panel reinforcement to the vehicle body, for example, weight increase of the entirety the joining members can be reduced.

One aspect of the present disclosure provides a joining structure. The joining structure comprises the aforementioned first joining member and the aforementioned second joining member. The instrument panel fastening surface includes an upper instrument panel fastening surface and a lower instrument panel fastening surface located downwards of the upper instrument panel fastening surface. Each of the upper instrument panel fastening surface and the lower instrument panel fastening surface is provided with the second fastening hole. The extending surface includes an upper extending surface that extends out from an edge of the upper instrument panel fastening surface and a lower extending surface that extends out from an edge of the lower instrument panel fastening surface. The upper instrument panel fastening surface is fastened to the upper body fastening surface. The lower instrument panel fastening surface is fastened to the lower body fastening surface.

The above configuration easily shortens a length of the transmission path via the first joining member and the second joining member, thereby enabling the joining structure to be improved in stiffness. As a result, the configuration of the joining structure is easily simplified and therefore, the joining structure can be inhibited from increasing in weight.

### BRIEF DESCRIPTION OF THE DRAWINGS

Example embodiments of the present disclosure will be described hereinafter with reference to the accompanying drawings, in which:

FIG. 1 is a perspective view schematically illustrating a state where an instrument panel reinforcement is joined to a body of a vehicle (hereinafter, referred to as “vehicle body”) with a joining structure;

FIG. 2 is a top view schematically illustrating the state where the instrument panel reinforcement is joined to the vehicle body with the joining structure;

FIG. 3 is a side view schematically illustrating the state where the instrument panel reinforcement is joined to the vehicle body with the joining structure;

FIG. 4 is a perspective view illustrating a first joining member;

FIG. 5 is a perspective view illustrating a second joining member;

FIG. 6 is a perspective view illustrating a state where the first joining member and the second joining member overlap each other;

FIG. 7 is a front view illustrating the state where the first joining member and the second joining member overlap each other; and

FIG. 8 is a side view illustrating a joining structure comprising a first joining member consisting of two components.

### DETAILED DESCRIPTION OF EXEMPLARY EMBODIMENTS

### 1. Configuration

### <Joining Structure>

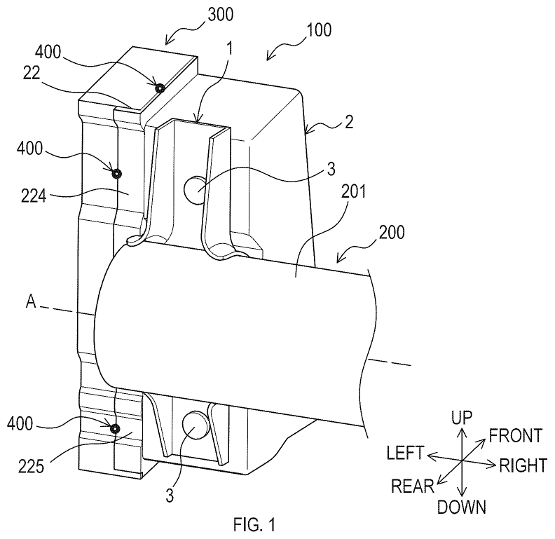

FIGS. 1 to 3 illustrate a joining structure 100. The joining structure 100 is used so as to joint, to a body of a vehicle (hereinafter, referred to as “vehicle body), an instrument panel reinforcement 200 to be mounted in a vehicle in an extending manner in a vehicle-width direction (in other words, left-right directions of the vehicle).

The instrument panel reinforcement 200 is a pipe-like member, and has a center axis A extending in the vehicle-width direction. As illustrated in FIG. 3, in the present embodiment, the instrument panel reinforcement 200 has a substantially circular shape in a cross-section orthogonal to the center axis A thereof. It should be noted that the shape of the instrument panel reinforcement in the cross-section orthogonal to the center axis is not limited to a circular shape, and an example shape may include a square shape. The instrument panel reinforcement 200 supports a steering.

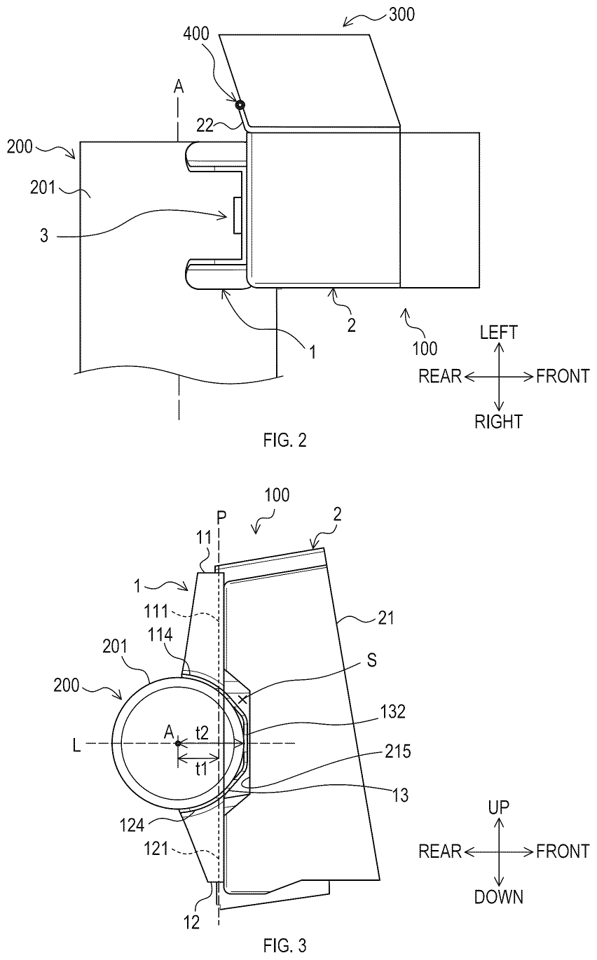

The joining structure 100 includes at least two joining structures 100. The respective two joining structures 100 are provided to both ends of the instrument panel reinforcement 200, and fixed to pillars 300 illustrated in FIGS. 1 and 2 by means of, for example, two or more weld portions 400 formed by spot-welding or the like. The pillars 300 configure the vehicle body, and include, for example, a driver side-pillar and a passenger side-pillar. Hereinafter, a top, a bottom, a front, a rear, a right, and a left of the vehicle are simply referred to as “top”, “bottom”, “front”, “rear”, “right”, and “left”. As illustrated in FIGS. 1 to 3, each joining structure 100 comprises a first joining member 1, a second joining member 2, and a fastening member 3. The joining structure 100 is formed such that the first joining member 1 and the second joining member 2 are fastened with the fastening member 3.

### <First Joining Member>

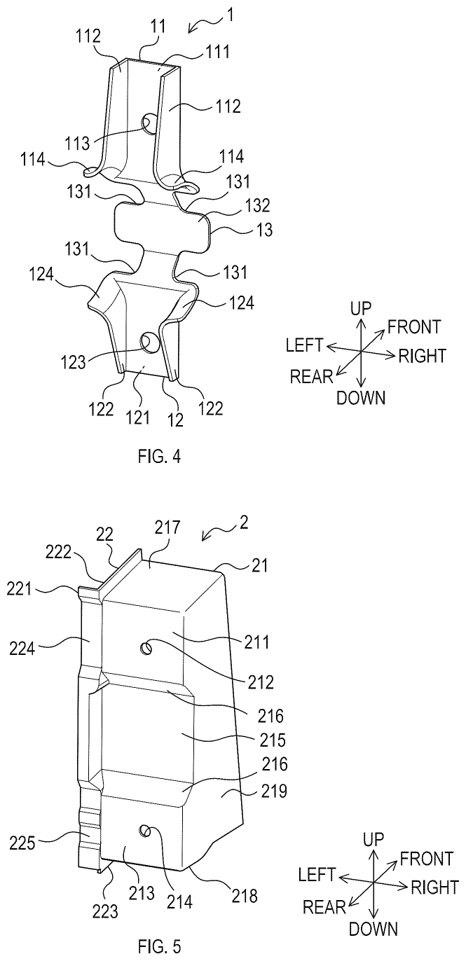

The first joining member 1 is, for example, a bracket. The first joining member 1 holds the instrument panel reinforcement 200 and is fastened to the vehicle body (in the present embodiment, the second joining member 2). As illustrated in FIG. 4, the first joining member 1 comprises an upper fastening portion 11, two upper walls 112, a lower fastening portion 12, two lower walls 122, and a coupling portion 13.

The upper fastening portion 11 is a flat plate having a rectangular shape, and includes an upper body fastening surface 111 used to be fastened to the second joining member 2, which will be described later. The upper body fastening surface 111 expands in up-down directions and left-right directions, and is substantially flat. A substantially flat surface may mean a flat surface, or a surface not fully flat with a slight curve or a slight bend. The upper fastening portion 11 is provided with a first upper fastening hole 113. The first upper fastening hole 113 penetrates through the upper body fastening surface 111 in the front-rear directions.

The two upper walls 112 extend out to the rear in a substantially perpendicular manner to the upper body fastening surface 111 from left and right edges of the upper fastening portion 11 extending in the up-down directions, respectively. At respective lower ends of the two upper walls 112, there are provided upper contact portions 114 that extend out outwards of the two upper walls 112 and contact an outer circumferential surface 201 of the instrument panel reinforcement 200.

The lower fastening portion 12 is located downwards of the upper fastening portion 11 at a position distanced from the upper fastening portion 11. The lower fastening portion 12 is a flat plate having a rectangular shape, and includes a lower body fastening surface 121 used to be fastened to the second joining member 2, which will be described later. The lower body fastening surface 121 expands in the up-down directions and the left-right directions, and is substantially flat. The lower fastening portion 12 is provided with a first lower fastening hole 123. The first lower fastening hole 123 penetrates through the lower body fastening surface 121 in the front-rear directions.

The two lower walls 122 extend out to the rear in a substantially perpendicular manner to the lower body fastening surface 121 from left and right edges of the lower fastening portion 12 extending in the up-down directions, respectively. At respective upper ends of the two lower walls 122, there are provided lower contact portions 124 that extend out outwards of the two lower walls 122 and contact the outer circumferential surface 201 of the instrument panel reinforcement 200.

The coupling portion 13 is a plate-like member curving along the outer circumferential surface 201 of the instrument panel reinforcement 200, and couples the upper fastening portion 11 and the lower fastening portion 12. In the present embodiment, the coupling portion 13 curves so as to protrude frontwards. The coupling portion 13 contacts the outer circumferential surface 201 of the instrument panel reinforcement 200. As illustrated in FIG. 3, the coupling portion 13 includes a flat surface 132 having a substantially flat shape in a center part thereof in a circumferential direction around the outer circumferential surface 201 of the instrument panel reinforcement 200.

As illustrated in FIGS. 4 and 7, the coupling portion 13 has a length in the left-right directions longer than respective lengths of the upper body fastening surface 111 and the lower body fastening surface 121 in the left-right directions. Specifically, the length in the left-right directions of the coupling portion 13 is longer than a distance between the two upper walls 112 and a distance between the two lower walls 122. The coupling portion 13 includes, at left and right edges thereof extending in the circumferential direction, two cutouts 131 aligned along the circumferential direction. Consequently, the coupling portion 13 can contact the outer circumferential surface 201 of the instrument panel reinforcement 200 in a fixed length along the center axis A, while being able to have a reduced area in its entirety due to the cutouts 131. As a result, the first joining member 1 can both stably hold the instrument panel reinforcement 200 and contribute to its light-weighting.

As illustrated in FIGS. 3 and 7, the first joining member 1 can hold the instrument panel reinforcement 200 between the upper fastening portion 11 and the lower fastening portion 12. In the present embodiment, the first joining member 1 holds the outer circumferential surface 201 of the instrument panel reinforcement 200 with the upper contact portions 114, the lower contact portions 124, and the coupling portion 13. In a cross-section orthogonal to the center axis A, the first joining member 1 covers only a part of the outer circumferential surface 201 of the instrument panel reinforcement 200 along the circumferential direction around the outer circumferential surface 201. In the present embodiment, the upper contact portions 114, the lower contact portions 124, and the coupling portion 13 cover about a half circumference of the outer circumferential surface 201 of the instrument panel reinforcement 200 in the circumferential direction.

As illustrated in FIG. 3, in a state where the first joining member 1 holds the instrument panel reinforcement 200, a distance t1 along an imaginary line L from the center axis A to an imaginary plane P is equal to or shorter than a distance t2 along the imaginary line L from the center axis A to the outer circumferential surface 201 of the instrument panel reinforcement 200. The imaginary plane P is a plane that connects the upper body fastening surface 111 and the lower body fastening surface 121. The imaginary line L is orthogonal to the imaginary plane P and passes through the center axis A of the instrument panel reinforcement 200 held by the first joining member 1. In the present embodiment, since the distance t2 is a radius of a circle formed by the outer circumferential surface 201 of the instrument panel reinforcement 200, the distance t1 is equal to or shorter than the radius.

At least one of the first upper fastening hole 113 in the upper fastening portion 11 or the first lower fastening hole 123 in the lower fastening portion 12 is located in the vicinity of the instrument panel reinforcement 200 held by the first joining member 1. In the present embodiment, as illustrated in FIG. 7, when the joining structure 100 is viewed in a front-to-rear direction, a center point of the first upper fastening hole 113 is located downwards of the center between an upper end of the upper fastening portion 11 and an upper end of the instrument panel reinforcement 200 held by the first joining member 1. That is, the vicinity of the instrument panel reinforcement 200 means being located downwards of the above-described center. It should be noted that a center point of the first lower fastening hole 123 may be located upwards of the center between a lower end of the lower fastening portion 12 and a lower end of the instrument panel reinforcement 200 held by the first joining member 1.

In the state where the first joining member 1 holds the instrument panel reinforcement 200, the first upper fastening hole 113 and the first lower fastening hole 123 are preferably located at line-symmetrical positions with respect to the center axis A of the instrument panel reinforcement 200 as an axis of symmetry. However, the first upper fastening hole 113 and the first lower fastening hole 123 may be located at positions that are not line-symmetrical.

### <Second Joining Member>

The second joining member 2 is, for example, a gusset that is a part of the vehicle body. The second joining member 2 is fastened to the above-described first joining member 1 and fixed to the pillar 300 by welding. As illustrated in FIG. 5, the second joining member 2 comprises a main body 21 and an extending part 22.

The main body 21 includes an upper instrument panel fastening surface 211, a second upper fastening hole 212, a lower instrument panel fastening surface 213, a second lower fastening hole 214, a lowered surface 215, two slanting surfaces 216, an upper surface 217, a lower surface 218, and a side surface 219.

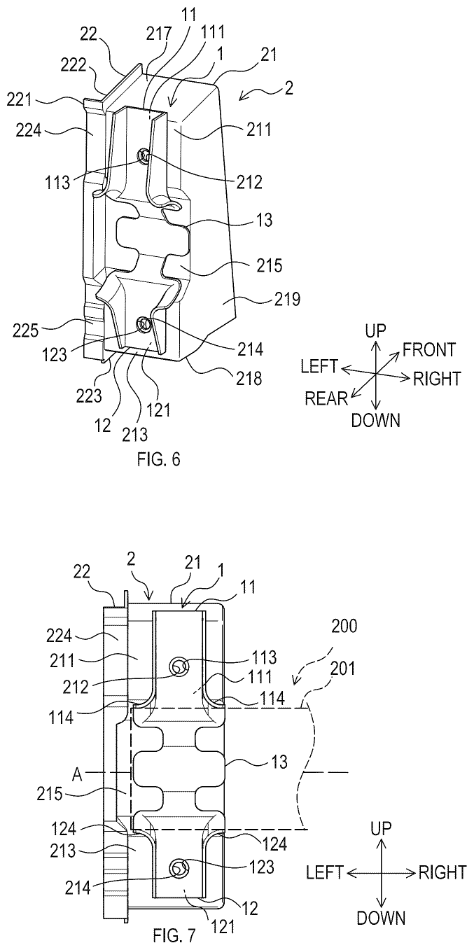

The upper instrument panel fastening surface 211 is a surface having a rectangular shape so as to join the instrument panel reinforcement 200 thereto via the first joining member 1. The upper instrument panel fastening surface 211 expands in the up-down directions and the left-right directions, and is substantially flat. The upper instrument panel fastening surface 211 is provided with the second upper fastening hole 212. The second upper fastening hole 212 penetrates through the upper instrument panel fastening surface 211 in the front-rear directions. As illustrated in FIG. 6, the upper instrument panel fastening surface 211 contacts the upper body fastening surface 111 such that the second upper fastening hole 212 overlaps the first upper fastening hole 113 in the upper body fastening surface 111 of the first joining member 1. Due to the fastening member 3 (for example, a bolt) illustrated in FIG. 1 being inserted through the second upper fastening hole 212 and the first upper fastening hole 113, the upper instrument panel fastening surface 211 is fastened to the upper body fastening surface 111. Consequently, the first joining member 1 is fixed to the second joining member 2.

As illustrated in FIG. 5, the lower instrument panel fastening surface 213 is located downwards of the upper instrument panel fastening surface 211 at a position distanced from the upper instrument panel fastening surface 211. The lower instrument panel fastening surface 213 is a rectangular surface so as to join the instrument panel reinforcement 200 thereto via the first joining member 1. The lower instrument panel fastening surface 213 expands in the up-down directions and the left-right directions, and is substantially flat. The lower instrument panel fastening surface 213 is provided with the second lower fastening hole 214. The second lower fastening hole 214 penetrates through the lower instrument panel fastening surface 213 in the front-rear directions. As illustrated in FIG. 6, the lower instrument panel fastening surface 213 contacts the lower body fastening surface 121 such that the second lower fastening hole 214 overlaps the first lower fastening hole 123 in the lower body fastening surface 121 of the first joining member 1. Due to the fastening member 3 (for example, a bolt) illustrated in FIG. 1 being inserted through the second lower fastening hole 214 and the first lower fastening hole 123, the lower instrument panel fastening surface 213 is fastened to the lower body fastening surface 121. Consequently, the first joining member 1 is fixed to the second joining member 2.

As illustrated in FIG. 5, the lowered surface 215 is a surface that has a rectangular shape and is located between the upper instrument panel fastening surface 211 and the lower instrument panel fastening surface 213. The lowered surface 215 expands in the up-down directions and the left-right directions, and is substantially flat. The lowered surface 215 is located frontwards of an imaginary plane P connecting the upper instrument panel fastening surface 211 and the lower instrument panel fastening surface 213. The upper instrument panel fastening surface 211 and the lowered surface 215, and the lower instrument panel fastening surface 213 and the lowered surface 215 are coupled via the respective two slanting surfaces 216. As illustrated in FIG. 3, in the state where the first joining member 1 is fastened to the second joining member 2, there is formed a space S to which the coupling portion 13 of the first joining member 1 can be fitted. In the state where the first joining member 1 is fastened to the second joining member 2, the lowered surface 215 contacts the flat surface 132 of the coupling portion 13 of the first joining member 1.

As illustrated in FIG. 5, the upper surface 217 extends out to the front from an upper edge of the upper instrument panel fastening surface 211 extending in the left-right directions.

The lower surface 218 faces the upper surface 217, and extends out to the front from a lower edge of the lower instrument panel fastening surface 213 extending in the left-right directions.

The side surface 219 extends out to the front from respective right edges of the upper instrument panel fastening surface 211, the lower instrument panel fastening surface 213, the lowered surface 215, and the two slanting surfaces 216, and couples the upper surface 217 and the lower surface 218. The side surface 219 faces the pillar 300.

The extending part 22 is located at a left end of the main body 21, and contacts the pillar 300. The extending part 22 includes a first extending part 221, a second extending part 222, and a third extending part 223.

The first extending part 221 is continuous to the upper instrument panel fastening surface 211, the lower instrument panel fastening surface 213, the lowered surface 215, and the two slanting surfaces 216, and has a plate-like shape extending in the up-down directions and the left-right direction. The first extending part 221 is arranged so as to have no differences in height with respect to the upper instrument panel fastening surface 211 and the lower instrument panel fastening surface 213. Furthermore, the first extending part 221 is arranged so as to have differences in height with respect to the lowered surface 215 and the two slanting surfaces 216. The first extending part 221 includes an upper extending surface 224 and a lower extending surface 225.

The upper extending surface 224 extends out from a left edge of the upper instrument panel fastening surface 211 extending in the up-down directions. The upper extending surface 224 expands in the up-down directions and the left-right directions, and is substantially flat. In the present embodiment, the upper extending surface 224 extends so as to make a slight bend to the rear with respect to the upper instrument panel fastening surface 211. It should be noted that the upper extending surface 224 and the upper instrument panel fastening surface 211 may extend in the same plane. As illustrated in FIG. 1, an edge of the upper extending surface 224 is provided with the weld portion 400 that joins the extending part 22 and the pillar 300. The second joining member 2 is substantially flat from the weld portion 400 in the upper extending surface 224 to the second upper fastening hole 212 in the upper instrument panel fastening surface 211.

As illustrated in FIG. 5, the lower extending surface 225 extends out from a left edge of the lower instrument panel fastening surface 213 extending in the up-down directions. The lower extending surface 225 expands in the up-down directions and the left-right directions, and is substantially flat. In the present embodiment, the lower extending surface 225 extends so as to make a slight bend to the rear with respect to the lower instrument panel fastening surface 213. It should be noted that the lower extending surface 225 and the lower instrument panel fastening surface 213 may extend in the same plane. As illustrated in FIG. 1, an edge of the lower extending surface 225 is provided with the weld portion 400 that joins the extending part 22 and the pillar 300. The second joining member 2 is substantially flat from the weld portion 400 in the lower extending surface 225 to the second lower fastening hole 214 in the lower instrument panel fastening surface 213.

As illustrated in FIG. 5, the second extending part 222 is continuous to the upper surface 217 and the first extending part 221, and has a plate-like shape extending in the up-down directions and the front-rear directions.

The third extending part 223 is continuous to the lower surface 218 and the first extending part 221, and has a plate-like shape extending in the up-down directions and the front-rear directions.

### 2. Effects

The embodiment detailed above can bring effects to be described below.

(2a) In the present embodiment, in the state where the first joining member 1 holds the instrument panel reinforcement 200, the distance t1 along the imaginary line L from the center axis A to the imaginary plane P is equal to or shorter than the radius of the circle formed by the outer circumferential surface 201 of the instrument panel reinforcement 200. Such a configuration easily shortens a length of a part of a path (transmission path) for transmitting a force from the steering supported by the instrument panel reinforcement 200 to the pillar 300. That is, the above configuration easily shortens a length of a path coupling the instrument panel reinforcement 200 and the upper body fastening surface 111 and a length of a path coupling the instrument panel reinforcement 200 and the lower body fastening surface 121. Due to shortening of the part of the transmission path, stiffness of the first joining member 1 can be improved. As a result, the configuration of the first joining member 1 is easily simplified and therefore, the first joining member 1 can be inhibited from increasing in weight.

(2b) In the present embodiment, the second joining member 2 is substantially flat from the weld portion 400 in the upper extending surface 224 to the second upper fastening hole 212 in the upper instrument panel fastening surface 211, and from the weld portion 400 in the lower extending surface 225 to the second lower fastening hole 214 in the lower instrument panel fastening surface 213. Such a configuration easily shortens a part of the transmission path, that is, a length of a path coupling the second upper fastening hole 212 in the upper instrument panel fastening surface 211 and the pillar 300, and a length of a path coupling the second lower fastening hole 214 in the lower instrument panel fastening surface 213 and the pillar 300. Due to shortening of the part of the transmission path, stiffness of the second joining member 2 can be improved. As a result, the configuration of the second joining member 2 is easily simplified and therefore, the second joining member 2 can be inhibited from increasing in weight.

(2c) As described above, in the present embodiment, since the transmission path in the first joining member 1 and the second joining member 2 is easily shortened, a length of the entire transmission path via the first joining member 1 and the second joining member 2 is easily shortened. Due to shortening of the entire transmission path, stiffness of the entire joining structure 100 can be improved. As a result, a configuration of the joining structure 100 is easily simplified and therefore, the joining structure 100 can be inhibited from increasing in weight.

(2d) In the present embodiment, the first joining member 1 can hold the instrument panel reinforcement 200 without covering the entirety of the outer circumferential surface 201 in the circumferential direction. Therefore, as compared to a configuration of covering the entirety of the outer circumferential surface 201 in the circumferential direction, the first joining member 1 can be inhibited from increasing in weight.

(2e) In the present embodiment, at least the first upper fastening hole 113 is located in the vicinity of the instrument panel reinforcement 200. Such a configuration easily shortens a length of a part of the transmission path, that is, a length of a path coupling the instrument panel reinforcement 200 and the first upper fastening hole 113 in the upper body fastening surface 111. Due to shortening of the part of the transmission path, the stiffness of the first joining member 1 can be improved. Furthermore, a length between the first upper fastening hole 113 and the first lower fastening hole 123 is easily shortened. Specifically, since a length of a part of the transmission path, that is, a length of a path coupling the first upper fastening hole 113 and the first lower fastening hole 123 is easily shortened, the stiffness of the first joining member 1 can be improved.

(2f) In the present embodiment, the upper fastening portion 11 including the upper body fastening surface 111 and the lower fastening portion 12 including the lower body fastening surface 121 are coupled via the coupling portion 13. Therefore, the first joining member 1 can be formed with a single component.

It should be noted that, in the present embodiment, the first upper fastening hole 113 and the first lower fastening hole 123 correspond to one example of the first fastening hole; and the second upper fastening hole 212 and the second lower fastening hole 214 correspond to one example of the second fastening hole.

### 3. Other Embodiments

Although the embodiment of the present disclosure has been described hereinabove, the present disclosure is not limited to the above-described embodiment and can be variously modified.

(3a) In the above-described embodiment, the joining structure 100 is provided at the end of the instrument panel reinforcement 200. However, a position to arrange the joining structure is not limited to the end of the instrument panel reinforcement 200. For example, in the instrument panel reinforcement from the end to a fixing member to fix the steering thereto, the joining structure may be arranged closer to the fixing member with respect to the end.

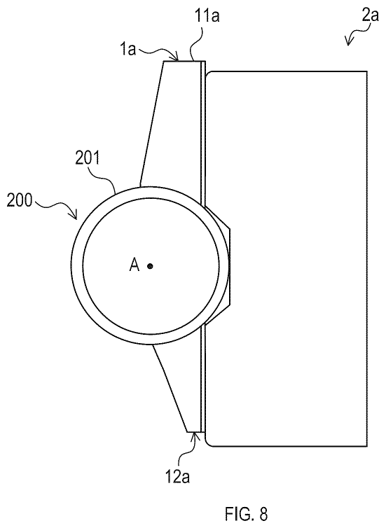

(3b) In the above-described embodiment, the first joining member 1 has a configuration of including the coupling portion 13. However, the first joining member 1 may have a configuration without the coupling portion. For example, as illustrated in FIG. 8, a first joining member 1a may include two components: an upper fastening portion 11a including an upper body fastening surface; and a lower fastening portion 12a including a lower body fastening surface. In this case, the instrument panel reinforcement 200 and the second joining member 2a are easily configured to come closer to each other.

(3c) The above-described embodiment shows an example configuration in which the joining structure 100 comprises the first joining member 1 and the second joining member 2. However, for example, the first joining member may be joined to the pillar 300, or the second joining member may be joined to the instrument panel reinforcement 200.

(3d) A single function performed by a single element in the above-described embodiments may be distributed to two or more elements. A single function achieved by two or more elements may be integrated into one element. Furthermore, a part of a configuration in the above-described embodiments may be omitted. Still further, at least a part of the configuration in the above-described embodiments may be added to or replaced with another configuration of the above-described embodiments.

### 4. Technical Ideas Disclosed in Present Disclosure

### Item 1

A first joining member configured to be used to join, to a body of a vehicle, an instrument panel reinforcement to be mounted in the vehicle in an extending manner in a vehicle-width direction, the first joining member comprising:
an upper body fastening surface configured to fasten the body thereto; and
a lower body fastening surface located downwards of the upper body fastening surface, the lower body fastening surface being configured to fasten the body thereto,
the first joining member being configured to be able to hold the instrument panel reinforcement between the upper body fastening surface and the lower body fastening surface,
there being defined an imaginary line orthogonal to an imaginary plane connecting the upper body fastening surface and the lower body fastening surface, and the imaginary line passing through a center axis, extending in the vehicle-width direction, of the instrument panel reinforcement held by the first joining member, and
a distance along the imaginary line from the center axis to the imaginary plane being equal to or shorter than a distance along the imaginary line from the center axis to an outer circumferential surface of the instrument panel reinforcement.

### Item 2

The first joining member according to Item 1,
wherein the first joining member is configured to cover a part of the outer circumferential surface in a circumferential direction around the outer circumferential surface, and
wherein at least one of a first fastening hole provided in the upper body fastening surface or a first fastening hole provided in the lower body fastening surface is located in a vicinity of the instrument panel reinforcement.

### Item 3

The first joining member according to Item 1 or 2, further comprising a coupling portion that couples the upper body fastening surface and the lower body fastening surface, the coupling portion being configured to hold the outer circumferential surface.

### Item 4

A second joining member configured to be used to join, to a body of a vehicle, an instrument panel reinforcement to be mounted in the vehicle in an extending manner in a vehicle-width direction, the second joining member comprising:
an instrument panel fastening surface configured to fasten the instrument panel reinforcement thereto; and
an extending surface that extends out from an edge of the instrument panel fastening surface,
the instrument panel fastening surface being provided with a second fastening hole,
the extending surface being provided with, at an edge thereof, a weld portion that joins the extending surface and the body, and
the second joining member being formed so as to be substantially flat from the weld portion in the extending surface to the second fastening hole in the instrument panel fastening surface.

### Item 5

A joining structure comprising:
the first joining member according to any one of Items 1 to 3; and
the second joining member according to Item 4,
the instrument panel fastening surface including an upper instrument panel fastening surface and a lower instrument panel fastening surface that is located downwards of the upper instrument panel fastening surface,
each of the upper instrument panel fastening surface and the lower instrument panel fastening surface being provided with the second fastening hole,
the extending surface including an upper extending surface that extends out from an edge of the upper instrument panel fastening surface, and a lower extending surface that extends out from an edge of the lower instrument panel fastening surface,
the upper instrument panel fastening surface being fastened to the upper body fastening surface, and
the lower instrument panel fastening surface being fastened to the lower body fastening surface.

What is claimed is:

1. A first joining member configured to be used to join, to a body of a vehicle, an instrument panel reinforcement to be mounted in the vehicle in an extending manner in a vehicle-width direction, the first joining member comprising:
an upper body fastening surface configured to fasten the body thereto; and
a lower body fastening surface located downwards of the upper body fastening surface, the lower body fastening surface being configured to fasten the body thereto,
the first joining member being configured to be able to hold the instrument panel reinforcement between the upper body fastening surface and the lower body fastening surface,
there being defined an imaginary line orthogonal to an imaginary plane connecting the upper body fastening surface and the lower body fastening surface, and the imaginary line passing through a center axis, extending in the vehicle-width direction, of the instrument panel reinforcement held by the first joining member, and
a distance along the imaginary line from the center axis to the imaginary plane being equal to or shorter than a distance along the imaginary line from the center axis to an outer circumferential surface of the instrument panel reinforcement.

2. The first joining member according to claim 1,
wherein the first joining member is configured to cover a part of the outer circumferential surface in a circumferential direction around the outer circumferential surface, and
wherein at least one of a first fastening hole provided in the upper body fastening surface or a first fastening hole provided in the lower body fastening surface is located in a vicinity of the instrument panel reinforcement.

3. The first joining member according to claim 1, further comprising a coupling portion that couples the upper body fastening surface and the lower body fastening surface, the coupling portion being configured to hold the outer circumferential surface.

4. The first joining member according to claim 3,
wherein the coupling portion has a length in the vehicle-width direction longer than respective lengths of the upper body fastening surface and the lower body fastening surface in the vehicle-width direction, and
wherein the coupling portion includes a cutout, at an edge of the coupling portion in the vehicle-width direction, the edge extending in a circumferential direction around the outer circumferential surface.

5. A second joining member configured to be used to join, to a body of a vehicle, an instrument panel reinforcement to be mounted in the vehicle in an extending manner in a vehicle-width direction, the second joining member comprising:
an instrument panel fastening surface configured to fasten the instrument panel reinforcement thereto; and
an extending surface that extends out from an edge of the instrument panel fastening surface,
the instrument panel fastening surface being provided with a second fastening hole,
the extending surface being provided with, at an edge thereof, a weld portion that joins the extending surface and the body, and
the second joining member being formed so as to be substantially flat from the weld portion in the extending surface to the second fastening hole in the instrument panel fastening surface.

6. A joining structure comprising:
the first joining member according to claim 1; and
a second joining member configured to be used to join, to the body of a vehicle, the instrument panel reinforcement to be mounted in the vehicle in an extending manner in a vehicle-width direction, the second joining member comprising: (i) an instrument panel fastening surface configured to fasten the instrument panel reinforcement thereto, and (ii) an extending surface that extends out from an edge of the instrument panel fastening surface, the instrument panel fastening surface being provided with a second fastening hole;
wherein:
the extending surface is provided with, at an edge thereof, a weld portion that joins the extending surface and the body;
the second joining member is formed to be substantially flat from the weld portion in the extending surface to the second fastening hole in the instrument panel fastening surface;
the instrument panel fastening surface includes an upper instrument panel fastening surface and a lower instrument panel fastening surface that is located downwards of the upper instrument panel fastening surface;
each of the upper instrument panel fastening surface and the lower instrument panel fastening surface is provided with the second fastening hole;
the extending surface includes an upper extending surface that extends out from an edge of the upper instrument panel fastening surface, and a lower extending surface that extends out from an edge of the lower instrument panel fastening surface;
the upper instrument panel fastening surface is fastened to the upper body fastening surface, and
the lower instrument panel fastening surface is fastened to the lower body fastening surface.
